(19) United States
(12) Patent Application Publication
(10) Pub. No.: US 2008/0003372 A1
(43) Pub. Date: Jan. 3, 2008

(54) Method for Curing Radically Curable Compounds in a Protective Atmosphere and Device for Carrying Out Said Method

(75) Inventors: Martin Kamps, Munster (DE); Fatmir Raka, Munster (DE); Hubert Baumgart, Munster (DE); Berthold Austrup, Nordkirchen (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, Münster (DE)

(21) Appl. No.: 11/569,213

(22) PCT Filed: May 24, 2005
(86) PCT No.: PCT/EP05/52395

§ 371 Date: Nov. 16, 2006

(30) Foreign Application Priority Data
Jun. 14, 2004 (DE) 10 2004 028 727.9

(51) Int. Cl. B05D 1/18; B05C 3/02

(52) U.S. Cl. 427/430.1; 118/400

(57) ABSTRACT

A method of curing free-radically curable compositions under an inert gas atmosphere, where the curing, which proceeds in accordance with a free-radical mechanism, is initiated, or initiated and maintained, in the free-radically curable compositions by radiation and the lateral escape of the inert gas atmosphere is prevented, which involves (1) immersing the free-radically curable compositions in an inert gas atmosphere below a depth from which the inert gas atmosphere constantly exhibits its lowest oxygen concentration, and (2) irradiating the free-radically curable compositions below this depth in the inert gas atmosphere, at least one of the radiation sources being arranged beneath the inert gas/air interface, and then (3) emersing the resultant cured compositions again from the inert gas atmosphere,
and apparatus (1) according to FIG. 1 for its implementation.

The present invention relates to a new method of curing free-radically curable compositions under an inert gas atmosphere. The present invention additionally relates to an apparatus for implementing the new method.

Free-radically radiation-curable compositions, especially free-radically radiation-polymerizable compositions, have numerous advantages. For instance they can be processed as 100% systems without water or organic solvents. In the course of their curing there is generally no damage to heat-sensitive substrates. In the course of radiation curing, however, the curing or polymerization may be severely inhibited by oxygen. Such inhibition results in incomplete curing of the compositions on the surface, leading, for example, to coatings which are tacky or lack scratch resistance.

The process known from international patent application WO 01/39897 A 1 attempts to alleviate this problem by irradiating the free-radically polymerizable compositions under an inert gas atmosphere composed of a gas which is heavier than air. For that purpose the free-radically polymerizable compositions, on substrates where appropriate, are immersed in a dip tank, which contains the inert gas atmosphere and prevents its lateral escape, and is irradiated therein with, for example, UV radiation. A disadvantage is that the distance of the radiation sources from the free-radically polymerizable compositions is frequently excessive, so that the problem of incomplete curing cannot be fully solved. Since the radiation sources also give off strong heat, it is not possible to bring them into the inert gas atmosphere, in order to reduce their distance from the free-radically polymerizable compositions, since that would produce strong vortexing in the inert gas atmosphere and contaminate it with oxygen.

It is an object of the present invention to find a new method of curing free-radically curable compositions under an inert gas atmosphere, where the curing, which proceeds in accordance with a free-radical mechanism, is initiated, or initiated and maintained, in the free-radically curable compositions by irradiation and the lateral escape of the inert gas atmosphere is prevented.

The new method shall no longer have the disadvantages of the prior art but instead shall in all cases, with simplicity, produce fully free-radically cured compositions, especially coatings, which exhibit the desired profile of performance properties, particularly an especially high scratch resistance.

The new method shall allow the free-radically curable compositions to be irradiated with a constantly low oxygen concentration without the possibility of vortexing of the inert gas atmosphere.

It is a further object of the present invention to provide a new apparatus with which the new method can be implemented with particular simplicity and reliability.

The new apparatus shall in particular allow the free-radically curable compositions to be immersed in and emersed from the inert gas atmosphere without the occurrence of vortexing during irradiation or of contamination of the inert gas atmosphere by oxygen, so that irradiation can be carried out with a constantly low oxygen concentration. The new apparatus shall also allow the distance of the radiation sources from the free-radically curable compositions to be varied, so that the optimum distance is ensured in all cases. The radiation sources shall not come into contact with the inert gas atmosphere, so as to rule out vortexing from the outset. The new apparatus shall not least make it possible to irradiate the free-radically curable compositions successively or simultaneously with different radiation sources.

The invention accordingly provides the new method of curing free-radically curable compositions under an inert gas atmosphere, where the curing, which proceeds in accordance with a free-radical mechanism, is initiated, or initiated and maintained, in the free-radically curable compositions by radiation and the lateral escape of the inert gas atmosphere is prevented, which involves
(1) immersing the free-radically curable compositions in an inert gas atmosphere below a depth from which the inert gas atmosphere constantly exhibits its lowest oxygen concentration, and
(2) irradiating the free-radically curable compositions below this depth in the inert gas atmosphere, at least one of the radiation sources being arranged beneath the inert gas/air interface, and then
(3) emersing the resultant cured compositions again from the inert gas atmosphere,
   which is referred to below as “method of the invention”.

The invention further provides the new apparatus (1) for implementing the method of the invention, comprising
an immersion station (1.2) which is open or opened at the top and is filled with an inert gas atmosphere (1.4), said station comprising
   a gastight-sealing base (1.9),
   three gastight-sealing sidewalls (1.3),
   one gastight-sealing sidewall (1.3.1) and
   an inert gas/air interface (1.4.1),
   in which from a depth (1.4.2) constantly the lowest oxygen concentration in the inert gas atmosphere (1.4) prevails;
an irradiation station (1.1), opened toward the immersion station (1.2) and filled with the inert gas atmosphere (1.4), said station (1.1) comprising
   a gastight-sealing base (1.9),
   two parallel, gastight-sealing sidewalls (1.3),
   a gastight wall (1.11) located above the base (1.9) and extending parallel thereto, and
   at least one radiation-permeable region (1.6) located in at least one wall (1.3) and/or the wall (1.11) and/or the base (1.9),
   in which constantly the lowest oxygen concentration in the inert gas atmosphere (1.4) prevails;
at least one radiation source (1.5) having at least one supply line for electrical energy (1.5.1);
at least one transport means (1.7) comprising
   a drive means (1.7.1),
   at least one passage (1.7.2) through a sidewall (1.3), the sidewall (1.3.2) or the base (1.9),
   a reversible traction means (1.7.3),
   a reversing means (1.7.4),
   a carrying means (1.7.5) which can be made to travel horizontally; and also
at least one free-radically curable composition (1.8), where appropriate on a substrate.

The new apparatus (1) for implementing the method of the invention is referred to below as “apparatus of the invention”.

In the light of the prior art it was surprising and unforeseeable for the skilled worker that the object on which the present invention was based could be achieved by means of the method of the invention and of the apparatus of the invention.

In particular it was surprising that the method of the invention in all cases produced simply, fully free-radically cured compositions, especially coatings, which exhibited the desired profile of performance properties, in particular a very high scratch resistance.

The method of the invention allowed the free-radically curable compositions to be irradiated with a constantly low oxygen concentration without the occurrence of vortexing of the inert gas atmosphere.

Suprisingly the apparatus of the invention allowed the method of the invention to be implemented with particular simplicity and reliability.

In particular the apparatus of the invention allowed for the free-radically curable compositions to be immersed in and emersed from the inert gas atmosphere without the occurrence of vortexing during irradiation or of contamination of the inert gas atmosphere by oxygen, so that the irradiation could be carried out with a constantly low oxygen concentration. Additionally the new apparatus allowed the distance of the radiation sources from the free-radically curable compositions to be varied, so that in all cases the optimum distance was ensured. The radiation sources did not come into contact with the inert gas atmosphere, so as to rule out vortexing from the outset. The apparatus of the invention made it possible not least to irradiate the free-radically curable compositions successively or simultaneously with different radiation sources.

Surprisingly it was found that, owing to the use of the method of the invention and of the apparatus of the invention, it was possible significantly to lower the photoinitiator content of the free-radically curable compositions, especially the free-radically polymerizable compositions, without the curing being slowed down and/or becoming incomplete. As a result of the lower photoinitiator content the resultant free-radically cured compositions were also less prone to yellowing and also no longer gave rise to any odor nuisance.

The method of the invention serves for curing free-radically curable compositions under an inert gas atmosphere. The curing, which proceeds in accordance with a free-radical mechanism, is initiated, or initiated and maintained, by radiation. The lateral escape of the inert gas atmosphere is prevented, for example, by means of container walls. The curing results in free-radically cured compositions, especially thermoset compositions, which are composed of a three-dimensional network.

The free-radically curable compositions contain bonds which can be activated with radiation, i.e., electromagnetic radiation, such as IR radiation, NIR radiation, visible light, UV radiation, x-rays and gamma radiation, and corpuscular radiation, such as electron beams, alpha radiation, beta radiation, neutron beams and proton beams; but preferably by electromagnetic radiation, especially NIR radiation, visible light and UV radiation.

Examples of suitable bonds which can be activated with actinic radiation and of reactive functional groups containing them are known from German patent application DE 101 29 970 A 1, page 8, paragraphs [0059] to [0061]. In particular (meth)acrylate groups are used.

The free-radically curable compositions may further contain reactive functional groups which are able to enter into crosslinking reactions with themselves or with complementary reactive functional groups, such as, for example, isocyanate groups on the one hand and isocyanate-reactive functional groups, such as hydroxyl groups, thiol groups and primary and secondary amino groups, on the other. The free-radically curable compositions in question are also referred to as dual-cure compositions.

The free-radically curable compositions that can be used in the method of the invention are not subject to any physical restriction, it being possible instead to use any of the aqueous, organic-solvent-containing, or water-free and solvent-free, liquid or pulverant, free-radically curable compositions known from the publications EP 0 540 884 A 1, EP 0 568 967 A 1, U.S. Pat. No. 4,675,234 A, DE 197 09 467 C 2, WO 01/39897 A 1, DE 42 15 070 A 1, DE 198 18 735 A 1, DE 199 08 018 A 1, DE 199 30 665 A 1, DE 199 30 067 A 1, DE 199 30 664 A 1, DE 199 24 674 A 1, DE 199 20 799 A 1, DE 199 58 726 A 1, DE 199 61 926 A 1, DE 100 42 152 A 1, DE 100 47 989 A 1, DE 100 55 549 A 1, DE 101 29 970 A 1, DE 102 02 565 A 1, DE 102 04 114 A 1, EP 0 928 800 A 1, EP 0 952 170 A 1 or DE 101 29 660 C 1.

Provided the free-radically curable compositions have the required dimensional stability, they can be used as such, i.e., without supporting substrates. Preferably the free-radically curable compositions are on planar or three-dimensionally shaped substrates, such as films or foils of metals or plastics, fibers, such as carbon fibers, glass fibers, textile fibers or metal fibers, or composites thereof, bodies of means of transport (including means of transport operated by engine power and/or muscle power, such as automobiles, commercial vehicles, buses, motorbikes, cycles, rail vehicles, watercraft and aircraft) and parts thereof, parts of buildings, doors, windows and furniture and parts thereof, mechanical, optical and electronic components and parts thereof, hollow glassware, containers, packaging, and articles of everyday use, and parts thereof, and small industrial parts, such as rims, bolts or nuts.

In the method of the invention it is preferred to use an inert gas atmosphere which is heavier than air. Preferably, therefore, the molecular weight of the inert gas is >28.8 daltons, this corresponding to the molecular weight of a mixture composed of 20% oxygen and 80% nitrogen. With particular preference the inert gas is selected from the group consisting of argon, hydrocarbons, halogenated hydrocarbons, sulfur hexafluoride and carbon dioxide. In particular, carbon dioxide is used.

The oxygen content of the inert gas atmosphere is preferably <15 percent, more preferably <10 percent, with particular preference <5 percent, more preferably <3 percent and in particular <2 percent by weight. In general it is sufficient for the oxygen content of the inert gas atmosphere to be between 1% and 2% by weight. In the case of free-radically curable compositions for which the oxygen has a particularly strong inhibiting effect, the oxygen content may also be <1 percent, preferably <0.5 percent and in particular <0.1 percent by weight.

For the method of the invention it is essential that the free-radically curable compositions are immersed into the inert gas atmosphere below a depth from which the inert gas atmosphere constantly has its lowest oxygen concentration and are irradiated beneath this depth in the inert gas atmosphere, at least one of the radiation sources being arranged beneath the inert gas/air interface. Preferably all of the radiation sources are arranged beneath this interface. In particular the radiation source or sources is or are located outside the inert gas atmosphere. The radiation source, or at least one of the radiation sources, can be arranged beneath, to the side of and/or above, in particular above, the free-radically curable compositions.

Preferably the free-radically curable compositions in the method of the invention, following immersion, are placed on a transport means. Subsequently they are transported to at least one irradiation station, where they are irradiated, thereby giving the free-radically cured compositions.

The free-radically cured compositions are transported to an emersion station, where they are emersed from the inert gas atmosphere.

In one preferred version of the method of the invention the immersion station and the emersion station are one and the same. In other words, the free-radically cured compositions are transported back again from the irradiation station to the immersion station, where they are emersed. This version is especially suitable for discontinuous implementation of the method of the invention, in batch operation.

In another preferred version of the method of the invention the emersion station is a separate station, which in particular follows the irradiation station on the side facing away from the immersion station. In other words, the free-radically cured compositions are transported on from the irradiation station to the emersion station, where they are emersed. This version is especially suitable for continuous implementation of the method of the invention, in continuous flow operation.

The method of the invention can be implemented with the aid of any of a very wide variety of apparatus. In accordance with the invention it is of advantage to use for this purpose the apparatus (1) of the invention.

The apparatus (1) of the invention comprises an immersion station (1.2) which is open or opened, i.e., closable at the top and is filled with the inert gas atmosphere (1.4). Said station (1.2) comprises a gastight-sealing base (1.9), three gastight-sealing sidewalls (1.3) and one gastight-sealing sidewall (1.3.1), and an inert gas/air interface. Prevailing constantly in the inert gas atmosphere (1.4) from a depth (1.4.2) is its lowest oxygen concentration.

Following the immersion station (1.2) there is an irradiation station (1.1), which is likewise filled with the inert gas atmosphere (1.4). The irradiation station (1.1) comprises a gastight-sealing base (1.9), two parallel, gastight-sealing sidewalls (1.3), and a gastight wall (1.11), which is located above the base (1.9) and extends parallel thereto. Preferably the immersion station (1.2) and the irradiation station (1.1) possess two continuous, parallel sidewalls (1.3) and a continuous base (1.9).

Not least, the irradiation station (1.1) comprises at least one, especially one, gastight region (1.6) which is transparent to the radiation from the radiation source or sources (1.5) and is located in at least one wall (1.3) and/or in the wall (1.11) and/or in the base (1.9).

The skilled worker is able to select the appropriate material for producing the transparent region (1.6) without a problem, on the basis of the transparency of the material for the radiation with which the free-radically curable compositions (1.8) are to be irradiated. Where appropriate, the transparent region (1.6) may comprise different regions which are transparent for different types of radiation.

Assigned to the irradiation station (1.1) and to the radiation-transparent region (1.6) is at least one radiation source (1.5) having at least one supply line for electrical energy. Examples of suitable radiation sources are conventional IR emitters, NIR emitters, lamps for visible light and UV lamps, especially lamps for visible light, such as halogen lamps, incandescent lamps, light-emitting diodes and lasers, and UV lamps, such as the UV lamps according to Römpp Lexikon Lacke und Druckfarben, Georg Thieme Verlag, Stuttgart, N.Y., 1998, pages 595 and 596, “UV lamps” and “UV Reflectors”, or the UV lamps described in German patent application DE 198 18 735 A 1, column 10, lines 31 to 61.

It is a particular advantage of the apparatus (1) of the invention that it is possible in each case to use not only one radiation source (1.5) but also any desired combination of radiation sources (1.5). Thus, for example, the free-radically curable compositions can be heated up with IR emitters before being irradiated with UV lamps. By this means it is possible to accelerate the curing very sharply, thereby further significantly reducing the cycle times in the apparatus (1) of the invention.

It is a further particular advantage of the apparatus (1) of the invention that the radiation sources (1.5) can be arranged so as to be displaceable in a vertical direction with respect to the free-radically curable compositions (1.8), so that in all cases it is possible to set the optimum distance between radiation sources (1.5) and free-radically curable compositions (1.8).

The apparatus (1) of the invention further comprises at least one, especially one, transport means (1.7). The transport means (1.7) may be surrounded substantially or entirely by the inert gas atmosphere (1.4).

The transport means (1.7) comprises at least one, especially one, drive means (1.7.1), an example being a steplessly adjustable motor operated with air pressure, or a steplessly adjustable electric motor.

The transport means (1.7) further comprises at least one passage (1.7.2) through a sidewall (1.3), through a sidewall (1.3.2) or through the base (1.9), in particular through the sidewall (1.3.2). Preferably there are two passages (1.7.2), each assigned to the other. If the drive means (1.7.1) is not located within the inert gas atmosphere (1.4), the passages (1.7.2) are of gastight design, this being accomplished, for example, by means of sliding seals.

The transport means (1.7) further comprises at least one, especially one, reversible traction means (1.7.3). The first part of the traction means (1.7.3) extends from the drive means (1.7.1) through one of the passages (1.7.2) to the carrier means (1.7.5), described below. On the other side the carrier means (1.7.5) is connected to the second part of the traction means (1.7.3), which via a reversing means (1.7.4), in particular a reversing roll, is passed back again through the second passage (1.7.2) to the drive means (1.7.1). Examples of suitable traction means (1.7.3) are cables or chains of plastic or metal, which may also be mounted appropriately.

The transport means (1.7) comprises not least a carrier means (1.7.5), which can be made to travel horizontally and with which at least one free-radically curable composition (1.8), where appropriate on a substrate, is transported from the immersion station (1.2) to the irradiation station (1.1). The carrier means (1.7.5) preferably comprises a platform mounted travelably, preferably on rollers or rails, which on its side facing the radiation source (1.5) possesses suitable means for the removable fastening of the free-radically curable composition or compositions (1.8), where appropriate on substrates.

In the case of the apparatus (1) of the invention the immersion station (1.2) may at the same time be the emersion station. In that case the irradiation station (1.1) comprises a sidewall (1.3.2) disposed perpendicularly to the sidewalls (1.3). This embodiment of the apparatus (1) of the invention is outstandingly suitable for implementing the method of the invention in discontinuous, batch operation.

Alternatively the apparatus of the invention (1) may further comprise an emersion station (1.10) which is filled with the inert gas atmosphere (1.4), is open or opened, i.e., reclosable, at the top, follows the exposure station (1.1) and comprises
a gastight-sealing base (1.9),
two gastight-sealing sidewalls (1.3),
one gastight-sealing sidewall (1.3.1),
one gastight-sealing sidewall (1.3.2), and
an inert gas/air interface (1.4.1),
   in which from a depth (1.4.2) constantly the lowest oxygen concentration prevails in the inert gas atmosphere (1.4). Preferably the immersion station (1.2), the irradiation station (1.1) and the emersion station (1.10) possess two continuous, parallel side walls (1.3) and one continuous base (1.9).

This embodiment of the apparatus (1) of the invention has the particular advantage that the sidewalls (1.3.1) can be displaced vertically in telescope fashion together with the wall (1.11) and the radiation source or radiation sources (1.5). Consequently, with this embodiment as well, it is possible in all cases to set the optimum distance of radiation source (1.5) from free-radically curable compositions (1.8). Preferably with this embodiment the transport means (1.7) is assigned to the sidewall (1.3.2) of the emersion station (1.10).

This embodiment possesses not least the very particular advantage that the traction means (1.7.3) and the carrier means (1.7.5) can be combined into a reversible carrier belt (1.7.3/1.7.5) which makes it possible, for example, to immerse a free-radically curable composition (1.8), present where appropriate on a substrate, in the immersion station (1.2) and to fix it therein, when a second free-radically curable composition (1.8) is already being irradiated in the irradiation station (1.1) and a third composition (1.8), which has already been free-radically cured, is taken from the carrier belt (1.7.3/1.7.5) in the emersion station (1.10) and is emersed.

This embodiment is outstandingly suitable for continuously implementing the method of the invention in continuous flow operation.

Irrespective of its embodiment, the apparatus (1) of the invention comprises means of generating and maintaining the inert gas atmosphere (1.4), of measuring the oxygen content, and of immersing the free-radically curable compositions (1.8), on substrates where appropriate, and emersing the resultant free-radically cured compositions (1.8), on substrates where appropriate. The apparatus (1) of the invention may further comprise conventional mechanical, pneumatic, electrical and electronic measurement and control devices.

In particular it is possible to produce and maintain the inert gas atmosphere (1.4) by passing in inert gas or by adding frozen inert gas, particularly dry ice, in the region of the base (1.9). In the case of this preferred procedure, particularly when inert gas is used that is heavier than air, the latter is displaced, free from vortexing, upwardly out of the apparatus of the invention, while in the lower region of the apparatus (1) a zone with a constant minimum oxygen concentration is formed. Where appropriate, the immersion station (1.2) and the emersion station (1.10) can be closed after they and the irradiation station (1.1) have been completely filled with inert gas and the free-radically curable compositions (1.8) have been immersed or emersed respectively. In this case it is advisable to provide a pressure compensation means, such as an overpressure valve.

Irrespective of the embodiment, the apparatus (I) of the invention is constructed from materials having the requisite corrosion stability, dimensional stability, mechanical stability, electrical conductivity, pressure stability and/or radiation stability for the purposes of the use of the invention. The skilled worker is able to select the materials in question without problems on the basis of his or her general art knowledge, with reference to their known physical, chemical and physiochemical properties.

Particularly advantageous embodiments of the apparatus (1) of the invention are illustrated with reference to FIGS. 1 to 4. FIGS. 1 to 4 are diagrammatic representations, intended to illustrate the principle of the invention. The diagrammatic representations, therefore, need not be true to scale. The size relationships depicted need not, therefore, correspond either to the size relationships employed in practice when implementing the invention.

FIG. 1 shows one preferred embodiment of the apparatus (1) of the invention in side elevation.

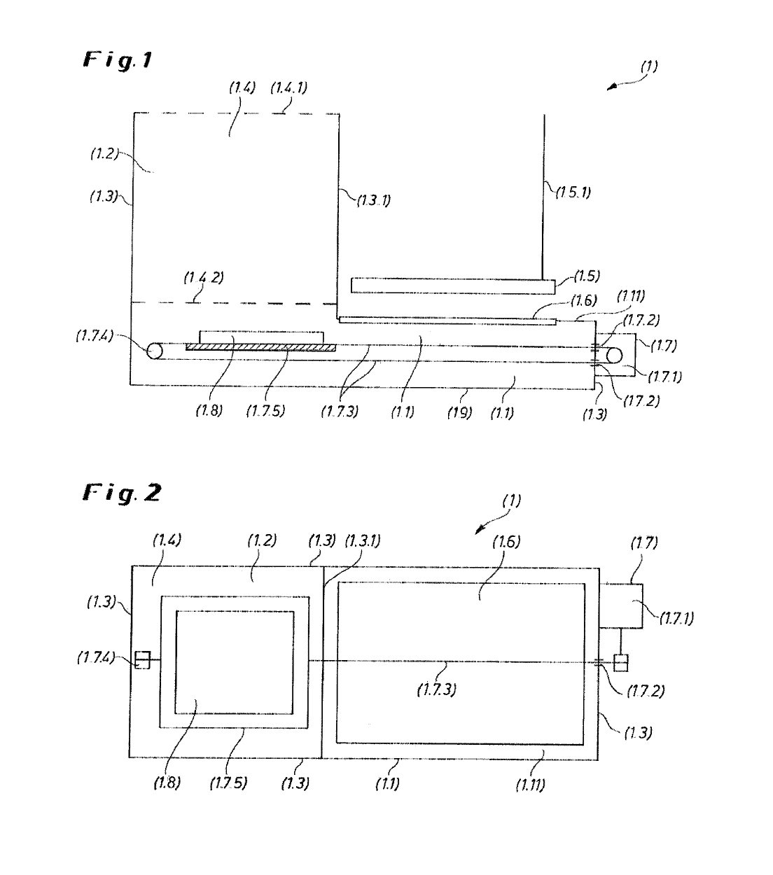

FIG. 2 shows the preferred embodiment of the apparatus (1) of the invention as per FIG. 1 in plan view.

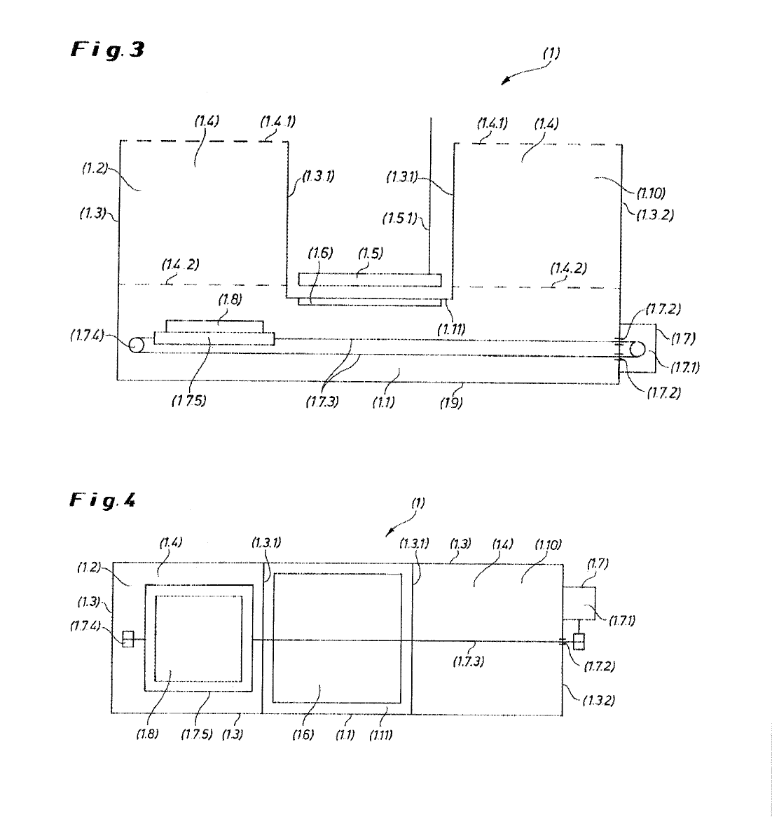

FIG. 3 shows another preferred embodiment of the apparatus (1) of the invention in side elevation.

FIG. 4 shows the preferred embodiment of the apparatus (1) of the invention as per FIG. 1 in plan view.

In FIGS. 1 to 4 the meanings of the reference numerals are as follows:
(1) inventive apparatus,
(1.1) irradiation station,
(1.2) immersion station,
(1.3) gastight sidewall,
(1.3.1) gastight sidewall in the region of the radiation source (1.5) and the irradiation station (1.1),
(1.3.2) gastight sidewall in the region of the irradiation station (1.1) and the transport means (1.7),
(1.4) inert gas atmosphere,
(1.4.1) inert gas/air interface,
(1.4.2) depth from which the inert gas atmosphere (1.4) constantly has its lowest oxygen concentration,
(1.5) radiation source or sources,
(1.5.1) energy supply,
(1.6) region transparent to the radiation from the radiation sources (1.5),
(1.7) transport means,
(1.7.1) drive means,
(1.7.2) passage through the sidewall (1.3.2),
(1.7.3) reversible traction means,
(1.7.4) reversing means,
(1.7.5) carrier means which can be made to travel horizontally,
(1.8) free-radically curable composition on a substrate where appropriate,
(1.9) gastight base,
(1.10) emersion station, and
(1.11) gastight wall extending parallel to the base (1.9).

When implementing the method of the invention using the apparatus (1) of the invention in accordance with FIGS. 1 and 2, for example, three-dimensional polymeric films coated with a layer of a transparent, UV-curable clearcoat material are immersed into the immersion station (1.2) and redetachably fastened to a transport car (1.7.5). The transport car and the coated substrates (1.8) are located beneath the depth (1.4.2) from which constantly the lowest oxygen concentration prevails in the inert gas atmosphere (1.4). With the aid of the transport means (1.7) the coated substrates (1.8) are guided on the transport car (1.7.5) to the irradiation station (1.1), where they are irradiated through the transparent region (1.6) with UV radiation from the radiation source (1.5) in the desired dose and intensity. This results in substrates coated with a highly scratch-resistant clearcoat (1.8). They are conveyed back with the aid of the transport means (1.7) to the immersion station (1.2) where they are emersed.

When implementing the method of the invention using the apparatus (1) of the invention in accordance with FIGS. 3 and 4, the substrates with the highly scratch-resistant clearcoat (1.8) are transported to the emersion station (1.10), where they are taken from the transport car (1.7.5) and emersed.

1. A method of curing free-radically curable compositions under an inert gas atmosphere comprising:
(1) immersing a free-radically curable composition in an inert gas atmosphere below a depth from which the inert gas atmosphere constantly exhibits its lowest oxygen concentration;
(2) irradiating the free-radically curable composition below this depth in the inert gas atmosphere, at least one radiation source being arranged beneath an inert gas/air interface; and
(3) emersing a resultant cured composition from the inert gas atmosphere,
where the method of curing proceeds in accordance with a free-radical mechanism, is initiated in the free-radically curable compositions by radiation and the lateral escape of the inert gas atmosphere is prevented.

2. The method of claim 1, wherein the at least one radiation source is located beneath the inert gas/air interface.

3. The method of claim 1, wherein the radiation source or sources is or are located outside the inert gas atmosphere.

4. The method as claimed in claim 1, wherein the at least one radiation source is disposed above the free-radically curable compositions.

5. The method of claim 1, wherein the at least one radiation source comprises at least one of electromagnetic radiation, corpuscular radiation, or a mixture thereof.

6. The method of claim 1, wherein the inert gas atmosphere is heavier than air.

7. The method of claim 6, wherein the inert gas is selected from the group consisting of argon, hydrocarbons, halogenated hydrocarbons, sulfur hexafluoride and carbon dioxide.

8. The method of claim 7, wherein the inert gas is carbon dioxide.

9. An apparatus (1) for implementing the method of claim 1, comprising:
an immersion station (1.2) comprising an opening and having an inert gas atmosphere therein (1.4), and further comprising:
a gastight-sealing base (1.9);
three gastight-sealing sidewalls (1.3);
one gastight-sealing sidewall (1.3.1); and
an inert gas/air interface (1.4.1),
wherein a depth (1.4.2) constantly exhibiting a lowest oxygen concentration in the inert gas atmosphere of the immersion station (1.4) prevails;
an irradiation station (1.1), opened toward the immersion station (1.2) and filled with the inert gas atmosphere (1.4), wherein the irradiation station (1.1) further comprises:
a gastight-sealing base (1.9);
two parallel, gastight-sealing sidewalls (1.3);
a gastight wall (1.11) located above the gastight-sealing base (1.9) and extending parallel thereto; and
at least one radiation-permeable gastight region (1.6) located in at least one of the gastight-sealing sidewall (1.3), the gastight wall (1.11), the base (1.9),
wherein the irradiation station is disposed at a depth constantly exhibitin the lowest oxygen concentration prevailing in the inert gas atmosphere (1.4);
at least one radiation source (1.5) having at least one supply line for electrical energy (1.5.1);
at least one transport means (1.7) comprising:
a drive means (1.7.1);
at least one passage (1.7.2) through a gastight-sealing sidewall not facing the at least one radiation source (1.3), or the base (1.9);
a reversible traction means (1.7.3);
a reversing means (1.7.4);
a carrier means (1.7.5) wherein the carrier means can be made to travel horizontally; and
at least one free-radically curable composition (1.8).

10. The apparatus (1) of claim 9, wherein the immersion station (1.2) also comprises an emersion station.

11. The apparatus (1) of 9, wherein the irradiation station (1.1) comprises a gastight-sealing sidewall (1.3.2) disposed perpendicularly to the gastight-sealing sidewalls (1.3).

12. The apparatus (1) of claim 9, further comprising an emersion station (1.10) comprising an opening and having filled an inert gas atmosphere (1.4) therein, is open or opened at the top, follows the irradiation station (1.1) further comprising:
a gastight-sealing base (1.9);
two gastight-sealing sidewalls (1.3);
one gastight-sealing sidewall (1.3.1);
one gastight-sealing sidewall (1.3.2); and
an inert gas/air interface (1.4.1);
in which from a depth (1.4.2) constantly the lowest oxygen concentration prevails in the inert gas atmosphere (1.4).

13. The apparatus (1) of claim 9, wherein at least the radiation source (1.5) is displaceable vertically with respect to the radiation-permeable gastight region (1.6).

14. The apparatus (1) of claim 13, wherein the radiation-permeable gastight region (1.6) is located in the gastight wall (1.11).

15. The apparatus (1) of claim 12, wherein the gastight-sealing sidewalls (1.3.1) are vertically displaceable in telescope fashion together with the gastight wall (1.11) and the at least one radiation source (1.5).

16. The apparatus (1) of claim 12, wherein the sidewall (1.3.2) comprises two passages (1.7.2) for the reversible traction means (1.7.3).

17. The apparatus (1) of claim 9, wherein the transport means (1.7) is located in the inert gas atmosphere (1.4).

18. The apparatus (1) of claim 9, comprising:
a means of generating or maintaining the inert gas atmosphere (1.4); and
a means of measuring the oxygen content,

19. The apparatus (1) of claim 9, wherein the at least one radiation sources (1.5) is selected from the group consisting of IR emitters, NIR emitters, lamps for visible light and UV lamps.

20. The apparatus (1) of claim 9, further comprising a means whereby a free-radically curable composition may be disposed on a substrate.

21. The apparatus (1) of claim 18 wherein the apparatus comprises:
a means of immersing the free-radically curable composition (1.8) on a substrate; and
a means of emersing a resultant, free-radically cured composition on a substrate.
